(19) United States
(12) Patent Application Publication
(10) Pub. No.: US 2012/0202029 A1
(43) Pub. Date: Aug. 9, 2012

(54) POROUS FILM FOR HEAT-SEALABLE BAG-CONSTITUTING MEMBER, HEAT-SEALABLE BAG-CONSTITUTING MEMBER AND DISPOSABLE BODY WARMER

(75) Inventor: Kaori Ohnishi, Matsuyama-shi, (JP)

(73) Assignee: NITTO LIKETEC CORPORATION, Matsuyama-shi (JP)

(21) Appl. No.: 13/502,868

(22) PCT Filed: Oct. 14, 2010
(86) PCT No.: PCT/JP2010/068006

§ 371 Date: Apr. 19, 2012

(30) Foreign Application Priority Data
Oct. 22, 2009 (JP) 2009-243129
Sep. 27, 2010 (JP) 2010-215216

(51) Int. Cl. B32B 5/24; B32B 5/32

(52) U.S. Cl. 428/213; 428/316.6; 442/372

(57) ABSTRACT

Provided are: a porous film for a heat-sealable bag-constituting member which has a high seal strength and is resistant to edge tear when heat-sealed to form a bag, and excels in workability (bag productivity); and a porous film for a heat-sealable bag-constituting member which enables the use of a polyolefinic nonwoven fabric to be laminated (combined) therewith. The porous film (11) for a heat-sealable bag-constituting member includes a porous film layer (layer A) (11a) and another porous film layer (layer B) (11b). Resinous component(s) constituting the layer A (11a) contains 50 percent by weight or more of at least one polyethylene (a) having a melting point of 90° C. or higher and lower than 110° C., and resinous component(s) constituting the layer B (11b) contains 50 percent by weight or more of at least one polyethylene (b) having a melting point of 110° C. or higher and 140° C. or lower.

### TECHNICAL FIELD

The present invention relates to a heat-sealable porous film for use as a bag-constituting member typically for a disposable body warmer. The present invention also relates to a heat-sealable bag-constituting member and a disposable body warmer each including the porous film.

### BACKGROUND ART

Porous films are now widely used typically in bag-constituting members for enclosing or housing heaters of disposable body warmers; and in bag-constituting members for housing dehumidifiers or deodorants (see, for example, Patent Literature (PTL) 1 and PTL 2).

The disposable body warmers have structures such as one illustrated in FIG. 4. Specifically, the structure is formed by subjecting two bag-constituting members to a heat sealing process to form a bag, and enclosing or housing a heater 3 containing, for example, an iron powder as a main component in the bag. The two bag-constituting members are a front member 6 and a back member 7 including a substrate 71 and a pressure-sensitive adhesive layer 72. A gas-permeable member including a composite member (laminated member) typically of a porous film and a nonwoven fabric is used as at least one of the bag-constituting members (generally as the front member 6), for satisfactorily feeding oxygen to the heater 3.

Although in areas other than bag-constituting members for body warmers, there have been known, as such porous films, a porous film including a linear low-density polyethylene (hereinafter also referred to as “LLDPE”) as a base polymer; and a porous composite member including such a porous film bonded through the medium of a hot-melt resin (adhesive) to a porous substrate such as a nonwoven fabric (see, for example, PTL 3).

### CITATION LIST

### Patent Literature

PTL 1: Japanese Unexamined Patent Application Publication (JP-A) No. H11-19113
PTL 2: Japanese Unexamined Patent Application Publication (JP-A) No. 2002-36471
PTL 3: Japanese Patent No. 2602016

### SUMMARY OF INVENTION

### Technical Problem

The LLDPE porous film with a single-layer structure may be used as a porous film layer to constitute a composite member including the porous film layer and a nonwoven fabric bonded to each other through a hot-melt resin layer, and the composite member may be used as a bag-constituting member (in which the LLDPE porous film layer serves as a heat-sealable layer) to form a bag through heat sealing. In this case, however, problems as mentioned below occur. Specifically, the porous film composed of LLDPE tends to tear at high temperatures and is thereby susceptible to edge tear when heat-sealed under intense or severe conditions (e.g., heat-seated at high temperatures) to form a bag. The edge tear is a phenomenon in which the film tears at the boundary region (edge region) between a heat-sealed portion and a non-heat-sealed portion. In contrast, when the porous film is heat-sealed under mild conditions to form a bag, the bag has an insufficient heat-seal strength (seal strength) and may thereby suffer from bag breakage. Thus, the porous film of this type has insufficient workability (i.e., bag productivity) upon use, because the range of appropriate conditions for heat sealing (production conditions) is narrow.

In addition, the LLDPE porous film of a single-layer structure, when used, should be heat-sealed at a relatively high temperature of from about 130° C. to 180° C. for a higher seal strength. This requires the use of a material having high thermal stability, such as a nylon or polyester material, as a material for the nonwoven fabric to be laminated (combined) with the porous film. If a nonwoven fabric being relatively inexpensive but having insufficient thermal stability, such as a polypropylene or polyethylene nonwoven fabric, is used, the nonwoven fabric may suffer from problems such as poor appearance of a sealed portion due to melting (filming) of the nonwoven fabric upon heat sealing, and rupture of the nonwoven fabric in the sealed portion. These problems impede the use of such inexpensive nonwoven fabric as polypropylene or polyethylene nonwoven fabric and thereby impede cost reduction of bag-constituting members.

Specifically, under present circumstances, there has not yet been obtained a porous film suitable as a heat-sealable bag-constituting member which excels in heat sealability and is resistant to edge tear.

Accordingly, an object of the present invention is to provide a porous film for a heat-sealable bag-constituting member, which has a high seal strength, is resistant to edge tear upon sealing, and excels in productivity when heat-sealed to form a bag. Another object of the present invention is to provide a porous film for a heat-sealable bag-constituting member, which enables the use of a nonwoven fabric formed from a polymer having a relatively low melting point, such as a polyolefinic polymer (particularly a polypropylene or polyethylene) as a nonwoven fabric to be laminated (combined) therewith. Yet another object of the present invention is to provide a heat-sealable bag-constituting member and a disposable body warmer each of which uses the porous film for a heat-sealable bag-constituting member and has good workability and satisfactory productivity.

### Solution to Problem

After intensive investigations to achieve the objects, the present inventor found that a porous film having at least a porous film layer including a specific polyethylene having a relatively high melting point as a principal resinous component, and another porous film layer including a specific polyethylene having a relatively low melting point as a principal resinous component can have both satisfactory sealability and satisfactory resistance to edge tear upon heat sealing; and that this porous film can serve as a porous film for a heat-sealable bag-constituting member which is heat-sealable under a relatively wide range of sealing conditions and thereby can give a bag with good workability (bag productivity). She also found that this porous film serves as a porous film for a heat-sealable bag-constituting member which enables the use of a nonwoven fabric including a polyolefinic polymer having a relatively low melting point as a nonwoven fabric to be combined with the porous film. The present invention has been made based on these findings.

Specifically, the present invention provides a porous film for a heat-sealable bag-constituting member. The porous film includes a porous film layer (layer A); and another porous film layer (layer B), in which resinous component(s) constituting the layer A contains 50 percent by weight or more of at least one polyethylene (a) having a melting point of 90° C. or higher and lower than 110° C., and resinous component(s) constituting the layer B contains 50 percent by weight or more of at least one polyethylene (b) having a melting point of 110° C. or higher and 140° C. or lower.

The porous film for a heat-sealable bag-constituting member preferably has a ratio in thickness of the layer A to the layer B [(layer A):(layer B)] of from 0.5:9.5 to 5.0:5.0 and has a total thickness of from 40 to 120 μm.

The present invention further provides, in another aspect, a heat-sealable bag-constituting member which includes the porous film for a heat-sealable bag-constituting member; and a nonwoven fabric layer provided above a surface of the layer B side of the porous film through the medium of an adhesive layer.

In the heat-sealable bag-constituting member, the nonwoven fabric layer is preferably a polyolefinic nonwoven fabric layer.

In addition and advantageously, the present invention provides a disposable body warmer having the heat-sealable bag-constituting member.

### ADVANTAGEOUS EFFECTS OF INVENTION

The porous film for a heat-sealable bag-constituting member according to the present invention has two porous film layers, which one porous film layer includes a polyethylene having a relatively low melting point as a principal resinous component and excels in heat sealability; and the other includes a polyethylene having a higher melting point as a principal resinous component and excels in thermal stability. The porous film therefore indicates satisfactory sealability (high seal strength) even when heat-sealed under relatively mild conditions (e.g., low-temperature conditions) and enables heat sealing under such relatively mild conditions. In addition, the porous film is resistant to edge tear upon sealing even when heat-sealed under somewhat intense conditions (e.g., high-temperature conditions). For these reasons, the porous film enables heat sealing under a wider range of sealing conditions than that in customary techniques, and this allows a heat-sealable bag-constituting member using the porous film to have better workability (bag productivity). In addition, the porous film is heat-sealable at relatively low temperatures, thereby enables the use of a polyolefinic nonwoven fabric (typified by a polypropylene or polyethylene nonwoven fabric) as a nonwoven fabric to be laminated (combined) with the porous film, and is advantageous in cost reduction.

### BRIEF DESCRIPTION OF DRAWINGS

FIG. 1 is a schematic cross-sectional view illustrating a bag-constituting member as an embodiment of the present invention.

FIG. 2 is a schematic cross-sectional view illustrating a disposable body warmer as an embodiment of the present invention.

FIG. 3 is a schematic plan view illustrating a disposable body warmer as an embodiment of the present invention, when viewed from above.

FIG. 4 is a schematic cross-sectional view illustrating an exemplary customary adhesive-patch disposable body warmer.

### DESCRIPTION OF EMBODIMENTS

### Porous Film for Heat-Sealable Bag-Constituting Member

A porous film for a heat-sealable bag-constituting member according to an embodiment of the present invention (hereinafter also simply referred to as a “porous film according to the present invention”) is a porous film including at least two polyethylene-containing porous film layers as essential constitutive layers. As used herein the term “layer A” refers to, of the essential porous film layers, a porous film layer whose constitutive resinous component(s) contains 50 percent by weight or more of at least one polyethylene having a melting point of 90° C. or higher and lower than 110° C. Also as used herein the term “layer B” refers to, of the essential porous film layers, a porous film layer whose constitutive resinous component(s) contains 50 percent by weight or more of at least one polyethylene having a melting point of 110° C. or higher and 140° C. or lower. In this connection, a porous film layer whose constitutive resinous components contain 50 percent by weight of at least one polyethylene having a melting point of 90° C. or higher and lower than 110° C. and 50 percent by weight of at least one polyethylene having a melting point of 110° C. or higher and 140° C. or lower is defined as a “layer A”.

The polyethylene having a melting point of 90° C. or higher and lower than 110° C. contained in the layer A is also referred to as a “polyethylene (a)”; whereas the polyethylene having a melting point of 110° C. or higher and 140° C. or lower contained in the layer B is also referred to as a “polyethylene (b)”. Specifically, the porous film according to the present invention is a porous film which includes at least a layer A and a layer B, in which resinous component(s) constituting the layer A contains 50 percent by weight or more of a polyethylene (a), and resinous component(s) constituting the layer B contains 50 percent by weight or more of a polyethylene (b). When two or more polyethylenes each having a melting point of 90° C. or higher and lower than 110° C. are contained in resinous components constituting the layer A, all the polyethylenes each having a melting point of 90° C. or higher and lower than 110° C. in the layer A are also synthetically referred to as “polyethylene (a)”. Likewise, when two or more polyethylenes each having a melting point of 110° C. or higher and 140° C. or lower are contained in resinous components constituting the layer B, all the polyethylenes each having a melting point of 110° C. or higher and 140° C. or lower in the layer B are also synthetically referred to as “polyethylene (b)”.

The melting point of the polyethylene (a) is not critical and may be measured, for example, by subjecting the layer A of the porous film as a measurement sample to a measurement through differential scanning calorimetry (DSC) according to Japanese Industrial Standards (JIS) K 7121. Likewise, the melting point of the polyethylene (b) may be measured in the same manner as above by subjecting the layer B as a measurement sample to a measurement through differential scanning calorimetry (DSC) according to JIS K 7121. Specifically, the measurement may be performed using the device name “DSC 200” supplied by Seiko Instruments Inc. as a measuring instrument at temperatures elevating from room temperature (23° C.) to 200° C. at a rate of temperature rise of 10° C./min

The porous film according to the present invention may further have one or more other layers than the layer A and the layer B. The layer A and the layer B may be laminated directly on each other without the medium of another layer or may be laminated on each other through the medium of another layer. From the viewpoint of interlayer bond strength, the layer A and the layer B are preferably laminated directly on each other without the medium of another layer. The “layer A” and the “layer B” in the present invention refer to layers each having a single-layer structure.

As used herein the term “polyethylene” refers to a polymer including ethylene as a principal monomer component, i.e., a polymer including ethylene-derived constitutional units (constitutional units corresponding to ethylene) as a principal constitutional unit (constitutional repeating unit) and is a polymer including 50 percent by weight or more (50 to 100 percent by weight) of ethylene-derived constitutional units in the molecule. Examples of such “polyethylene”s include ethylene homopolymers; and copolymers of ethylene and an α-olefin monomer having 3 to 8 carbon atoms [e.g., propylene, butene-1, pentene-1, hexene-1,4-methyl-pentene-1, heptene-1, or octene-1]. The “polyethylene” may also be a mixture of a homopolymer and a copolymer as mentioned above; or a mixture of two or more different copolymers.

### (Layer A)

The layer A is a porous film layer which serves as an essential constitutional layer in the porous film according to the present invention. The layer A contains the polyethylene (a) in a content of 50 percent by weight or more based on the total amount of resinous component(s) constituting the layer A. Specifically, the layer A contains the polyethylene (a) as a principal resinous component. The layer A may further contain one or more other resinous components than the polyethylene (a). The layer A preferably further contains an inorganic filler (inorganic bulking agent) in addition to such resinous components and may further contain any of other additives.

The layer A in the present invention is preferably provided as a surface layer (outer surface) of the porous film and is more preferably provided as a surface layer to be in contact with a counter bag-constituting member. When a bag-constituting member has the porous film according to the present invention, an adhesive layer, and a nonwoven fabric layer, the layer A is preferably provided as a surface layer of the porous film according to the present invention opposite to the adhesive layer and the nonwoven fabric layer. In other words, the layer A is preferably provided as a surface layer of the bag-constituting member. The layer A, when provided as a heat-sealable layer excellent in heat sealability at low temperatures, helps the bag-constituting member according to the present invention to have a high seal strength even when heat-sealed under relatively mild conditions (e.g., low-temperature conditions), thus being desirable.

The polyethylene (a) is a polymer (or polymers) including ethylene as a principal monomer component as described above and is not limited as long as having a melting point of 90° C. or higher and lower than 110° C. Examples of the polyethylene (a) include linear low-density polyethylenes (LLDPEs), ethylene-α-olefin copolymers (of which ethylene-α-olefin copolymerized elastomers are preferred), and mixtures of them. More specifically, preferred examples thereof include a polyethylene composed of LLDPE alone (100 percent by weight); and a polyethylene as a mixture of LLDPE and an ethylene-α-olefin copolymerized elastomer. In the latter case, the blending ratio (weight ratio) of LLDPE to the ethylene-α-olefin copolymerized elastomer [LLDPE: ethylene-α-olefin copolymerized elastomer] is preferably from 95:5 to 60:40, and more preferably from 90:10 to 70:30.

The linear low-density polyethylene for use as the polyethylene (a) is a linear polyethylene which is obtained through polymerization of ethylene with an α-olefin monomer having 4 to 8 carbon atoms and has short-chain branches. The short-chain branches each preferably have 1 to 6 carbon atoms in terms of its length. Preferred α-olefin monomers for use in the linear low-density polyethylene include 1-butene, 1-octene, 1-hexene, and 4-methylpentene-1. Of such linear low-density polyethylenes, so-called metallocene-catalyzed linear low-density polyethylenes (metallocene-catalyzed LLDPEs) prepared by using a metallocene catalyst are particularly preferred from the viewpoint of more satisfactory heat sealability.

The linear low-density polyethylene for use as the polyethylene (a) has a density of preferably from 0.850 to 0.915 g/cm³ and more preferably 0.900 g/cm³ or more and less than 0.910 g/cm³.

As used herein the term “density” refers to a density determined according to JIS K 6922-2 and JIS K 7112.

Though not critical, the linear low-density polyethylene for use as the polyethylene (a) has a weight-average molecular weight of preferably from 3×10⁴ to 20×10⁴, and more preferably from 3×10⁴ to 10×10⁴. The weight-average molecular weight herein may be measured according to GPC (gel permeation chromatography) techniques. Among them, the weight-average molecular weight is preferably measured according to a high-temperature GPC technique using a high-temperature GPC system. Specific examples of such technique include the high-temperature GPC technique described in Japanese Unexamined Patent Application Publication (JP-A) No. 2009-184705.

Though not critical, the linear low-density polyethylene has a melt flow rate (MFR) at 190° C. of preferably from 1.0 to 5.0 (g/10 min), and more preferably from 2.0 to 4.0 (g/10 min). The range is preferred from the viewpoint of extrusion workability. The MFR herein may be measured in accordance with the International Organization for Standardization (ISO) standard 1133 (or JIS K 7210).

The ethylene-α-olefin copolymer for use as the polyethylene (a) is a copolymer of ethylene and an α-olefin monomer having 4 to 8 carbon atoms, of which an ethylene-α-olefin copolymerized elastomers is preferred. Among them, an ethylene-α-olefin copolymerized elastomer using butene-1 as the α-olefin is preferred. The ethylene-α-olefin copolymer has the function of further improving heat sealability of the layer A.

The ethylene-α-olefin copolymer (particularly ethylene-α-olefin copolymerized elastomer) has a density of preferably less than 0.900 g/cm³, more preferably from 0.860 to 0.890 g/cm³, and furthermore preferably from 0.870 to 0.890 g/cm³.

Though not critical, the ethylene-α-olefin copolymer (particularly ethylene-α-olefin copolymerized elastomer) has a weight-average molecular weight of preferably from 5×10⁴ to 20×10⁴, and more preferably from 8×10⁴ to 15×10⁴. Also though not critical, the ethylene-α-olefin copolymer (particularly ethylene-α-olefin copolymerized elastomer) has a melt flow rate (MFR) at 190° C. of preferably from 1.0 to 5.0 (g/10 min), and more preferably from 2.0 to 4.0 (g/10 min) for satisfactory extrusion workability.

From the viewpoint of more satisfactory heat sealability at low temperatures, the polyethylene (a) may have a melting point (Tm) of 90° C. or higher and lower than 110° C., preferably from 95° C. to 105° C., and more preferably from 95° C. to 100° C. A polyethylene having a melting point of lower than 90° C., if used instead of the polyethylene (a), may cause the porous film to have insufficient blocking resistance (antiblocking property) and insufficient thermal stability. In contrast, a polyethylene having a melting point of 110° C. or higher, if used instead of the polyethylene (a), may cause the porous film to have insufficient heat sealability at low temperatures and to have an insufficient heat-seal strength when heat-sealed under mild conditions (at a low temperature and/or for a short time). To avoid these, the porous film should be subjected to heat sealing under relatively intense conditions (at a high temperature and/or for a long time). This may cause problems such that the range of appropriate heat sealing conditions is narrowed and that the range of nonwoven fabrics usable in the bag-constituting member is limited, namely, polyolefinic nonwoven fabrics (particularly polypropylene nonwoven fabrics, polyethylene nonwoven fabrics, and polypropylene/polyethylene blend nonwoven fabrics) are difficult to be used.

The layer A may further include one or more resinous components (additional resinous components) other than the polyethylene (a). Examples of the resinous components (additional resinous components) other than the polyethylene (a) include, but are not limited to, polyethylene resins other than the polyethylene (a); and polyolefinic resins (olefinic resins) other than polyethylenes, such as polypropylene resins (e.g., polypropylenes and propylene-α-olefin copolymers), polybutene resins (e.g., polybutene-1), and poly-4-methylpentene-1.

Though not critical, the content of resinous component(s) in the layer A is preferably from 40 to 70 percent by weight and more preferably from 40 to 60 percent by weight based on the total weight (100 percent by weight) of the layer A, from the viewpoint of aeration properties (gas permeability).

The content of the polyethylene (a) in resinous component(s) constituting the layer A is 50 percent by weight or more (from 50 to 100 percent by weight) to serve as a principal resinous component, preferably from 70 to 100 percent by weight, and more preferably from 90 to 100 percent by weight, based on the total weight (100 percent by weight) of resinous component(s) constituting the layer A. When two or more polyethylenes each having a melting point of 90° C. or higher and lower than 110° C. are contained in resinous components constituting the layer A, the term “content of the polyethylene (a) in resinous component(s) constituting the layer A” refers to the total sum of contents (total content) of all the polyethylenes each having a melting point of 90° C. or higher and lower than 110° C. contained in the resinous components constituting the layer A.

Though not critical, the content of the polyethylene (a) in the layer A is preferably from 40 to 70 percent by weight, and more preferably from 40 to 60 percent by weight, based on the total weight (100 percent by weight) of the layer A.

The layer A preferably further contains an inorganic filler (one or more inorganic fillers). The inorganic filler helps the layer A to be porous through drawing (stretching), because voids (pores) are formed around the filler upon drawing. Exemplary inorganic fillers include talc, silica, stone powder (chalk), zeolite, alumina, aluminum powder, and iron powder; as well as metal salts of carbonic acid, such as calcium carbonate, magnesium carbonate, magnesium-calcium carbonate, and barium carbonate; metal salts of sulfuric acid, such as magnesium sulfate and barium sulfate; metal oxides such as zinc oxide, titanium oxide, and magnesium oxide; metal hydroxides such as aluminum hydroxide, magnesium hydroxide, zirconium hydroxide, calcium hydroxide, and barium hydroxide; metal hydrates (hydrated metallic compounds) such as hydrates of magnesium oxide-nickel oxide and hydrates of magnesium oxide-zinc oxide. Among them, calcium carbonate and barium sulfate are preferred. The inorganic filler is not limited in its shape, may be in the form typically of plate or granule, but is preferably in the form of granule (particle) from the viewpoint of void (pore) formation through drawing. The inorganic filler is particularly preferably inorganic particles (inorganic microparticles) formed from calcium carbonate.

Though not critical, the inorganic filler (inorganic particles) has a particle size (average particle diameter) of typically preferably from 0.1 to 10 μm, and more preferably from 0.5 to 5 μm. An inorganic filler having a particle size of less than 0.1 μm may not sufficiently contribute to void formation; whereas an inorganic filler having a particle size of more than 10 μm may cause breakage upon film formation or poor appearance of the resulting film.

Though not critical, the inorganic filler (inorganic particles) may be contained in the layer A in a content of typically preferably from 30 to 60 percent by weight, and more preferably from 40 to 60 percent by weight based on the total weight (100 percent by weight) of the layer A. An inorganic filler, if contained in a content of less than 30 percent by weight, may not sufficiently contribute to void formation; whereas an inorganic filler, if contained in a content of more than 60 percent by weight, may cause breakage upon film formation or poor appearance of the film.

In addition to the resinous components and inorganic filler, the layer A may further contain one or more additives within ranges not adversely affecting the advantageous effects of the present invention. Exemplary additives include colorants, age inhibitors, antioxidants, ultraviolet absorbers, flame retardants, and stabilizers.

### (Layer B)

The layer B is a porous film layer which serves as an essential constitutional layer in the porous film according to the present invention. The layer B includes the polyethylene (b) in a content of 50 percent by weight or more based on the total amount of resinous component(s) constituting the layer B. Specifically, the layer B contains the polyethylene (b) as a principal resinous component. The layer B may further contain one or more other resinous components than the polyethylene (b). The layer B preferably further contains an inorganic filler in addition to such resinous components and may further contain any of other additives.

The layer B in the present invention is preferably provided as an underlayer (core layer) of the porous film and is more preferably provided as an underlayer with respect to the surface layer to be in contact with a counter bag-constituting member when the porous film is processed as a bag-constituting member to form a bag. When the bag-constituting member has the porous film according to the present invention, an adhesive layer, and a nonwoven fabric layer, the layer B is preferably provided as a layer of the porous film according to the present invention on which the adhesive layer and the nonwoven fabric layer are to be provided. Specifically, the layer B is preferably provided as an underlayer with respect to the surface layer of the bag-constituting member. The layer B may be provided as an intermediate layer, both sides of which are adjacent to surface layers, respectively. The layer B, when provided as an underlayer excellent in thermal stability, helps the bag-constituting member according to the present invention to be resistant to edge tear upon heat sealing, thus being desirable.

The polyethylene (b) is a polymer including ethylene as a principal monomer component as described above, is not limited, as long as having a melting point of 110° C. or higher and 140° C. or lower, but is exemplified by linear low-density polyethylenes (LLDPEs), high-density polyethylenes (HDPEs), and mixtures of them. More specifically, a preferred example of the polyethylene (b) is a polyethylene including LLDPE alone (100 percent by weight).

The linear low-density polyethylene for use as the polyethylene (b) is a linear polyethylene being obtained through polymerization of ethylene with an α-olefin monomer having 4 to 8 carbon atoms and has short-chain branches. The short-chain branches each preferably have 1 to 6 carbon atoms in terms of its length. Preferred α-olefin monomers for use in the linear low-density polyethylene include 1-butene, 1-octene, 1-hexene, and 4-methylpentene-1. Of such linear low-density polyethylenes, so-called metallocene-catalyzed linear low-density polyethylenes (metallocene-catalyzed LLDPEs) prepared by using a metallocene catalyst are preferred from the viewpoint of satisfactory affinity between the layer B and the layer A.

The linear low-density polyethylene for use as the polyethylene (b) has a density of preferably from 0.910 to 0.930 g/cm³, and more preferably from 0.910 to 0.920 g/cm³.

Though not critical, the linear low-density polyethylene for use as the polyethylene (b) has a weight-average molecular weight of preferably from 3×10⁴ to 20×10⁴, and more preferably from 3×10⁴ to 15×10⁴. Also though not critical, the linear low-density polyethylene has a melt flow rate (MFR) at 190° C. of preferably from 1.0 to 5.0 (g/10 min), and more preferably from 2.0 to 4.0 (g/10 min), from the viewpoint of extrusion workability.

The high-density polyethylene (HDPE) can be any of known or customary high-density polyethylenes each having a density of more than 0.930 g/cm³. The high-density polyethylene has a density of preferably more than 0.930 g/cm³ and 0.960 g/cm³ or less, and more preferably more than 0.930 g/cm³ and 0.950 g/cm³ or less.

Though not critical, the high-density polyethylene has a weight-average molecular weight of preferably from 5×10⁴ to 30×10⁴, and more preferably from 5×10⁴ to 20×10⁴. Also though not critical, the high-density polyethylene has a melt flow rate (MFR) at 190° C. of preferably from 1.0 to 5.0 (g/10 min), and more preferably from 2.0 to 4.0 (g/10 min). This range is preferred from the viewpoint of extrusion workability.

The polyethylene (b) may include a polyethylene having a molecular weight of 30×10⁴ or more (more preferably 35×10⁴ or more, and furthermore preferably 35×10⁴ to 300×10⁴). The polyethylene (b), when including a polyethylene having a molecular weight of 30×10⁴ or more (high-molecular-weight component), may help the layer B to have furthermore satisfactory thermal stability and may thereby help the porous film to be more resistant to edge tear upon heat sealing under more intense (severe) conditions, thus being desirable. The polyethylene having a molecular weight of 30×10⁴ or more may be contained in the polyethylene (b) in a content of preferably 1.0 percent by weight or more, and more preferably from 1.0 to 30 percent by weight, based on the total weight (100 percent by weight) of the polyethylene (b). The specific polyethylene, if contained in a content of less than 1.0 percent by weight, may not effectively help the porous film to have more satisfactory thermal stability; whereas if contained in a content of more than 30 percent by weight, may cause the porous film to suffer from inferior extrusion or defects (fish eyes).

The polyethylene (b) has a melting point (Tm) of 110° C. or higher and 140° C. or lower, preferably from 115° C. to 130° C., and more preferably from 115° C. to 125° C. This range is preferred from the viewpoint of thermal stability. A polyethylene having a melting point of lower than 110° C., if used instead of the polyethylene (b), may cause the porous film to have insufficient thermal stability and to be susceptible to edge tear upon heat sealing. In contrast, a polyethylene having a melting point of higher than 140° C., if used instead of the polyethylene (b), may cause the layer B to have poor affinity for the layer A upon coextrusion. Specifically, upon coextrusion, a material for constituting the layer A and a material for constituting the layer B may significantly differ from each other in properties such as melt viscosity and fluidity, and this may cause problems such as uneven thickness.

The layer B may further contain one or more resinous components (additional resinous components) other than the polyethylene (b). Examples of the resinous components (additional resinous components) other than the polyethylene (b) include, but are not limited to, polyethylene resins other than the polyethylene (b); and polyolefinic resins other than polyethylenes, such as polypropylene resins (e.g., polypropylenes and propylene-α-olefin copolymers), polybutene resins (e.g., polybutene-1), and poly-4-methylpentene-1.

Though not critical, the content of resinous component(s) in the layer B is preferably from 40 to 70 percent by weight and more preferably from 40 to 60 percent by weight based on the total weight (100 percent by weight) of the layer B, from the viewpoint of aeration properties (gas permeability).

The content of the polyethylene (b) in resinous component(s) constituting the layer B is 50 percent by weight or more (from 50 to 100 percent by weight) to serve as a principal resinous component, preferably from 70 to 100 percent by weight, and more preferably from 90 to 100 percent by weight based on the total weight (100 percent by weight) of the resinous component(s) constituting the layer B. When two or more polyethylenes each having a melting point of 110° C. or higher and 140° C. or lower are contained in the resinous components constituting the layer B, the term “content of the polyethylene (b) in resinous component(s) constituting the layer B” refers to the total sum of contents (total content) of all the polyethylenes each having a melting point of 110° C. or higher and 140° C. or lower in the resinous components constituting the layer B.

Though not critical, the content of the polyethylene (b) in the layer B is preferably from 40 to 70 percent by weight, and more preferably from 40 to 60 percent by weight, based on the total weight (100 percent by weight) of the layer B.

The layer B preferably further contains an inorganic filler (one or more inorganic fillers). The inorganic filler helps the layer B to be porous through drawing, because voids (pores) are formed around the filler upon drawing. The inorganic filler usable herein can be any of inorganic fillers of the same type and/or having the same shape as with the inorganic fillers listed with respect to the layer A. Among them, calcium carbonate and barium sulfate are preferred as the inorganic filler, of which inorganic particles (inorganic microparticles) composed of calcium carbonate are more preferred, as in the layer A.

Though not critical, the inorganic filler (inorganic particles) has a particle size (average particle diameter) of typically preferably from 0.1 to 10 μm, and more preferably from 0.5 to 5 μm. An inorganic filler having a particle size of less than 0.1 μm may not sufficiently contribute to void formation; whereas an inorganic filler having a particle size of more than 10 μm may cause breakage upon film formation or poor appearance of the resulting film.

Though not critical, the inorganic filler (inorganic particles) may be contained in the layer B in a content of typically preferably from 30 to 60 percent by weight, and more preferably from 40 to 60 percent by weight, based on the total weight (100 percent by weight) of the layer B. An inorganic filler, if contained in a content of less than 30 percent by weight, may not sufficiently contribute to void formation; whereas an inorganic filler, if contained in a content of more than 60 percent by weight, may cause breakage upon film formation or poor appearance of the film.

In addition to the resinous components and inorganic filler, the layer B may further contain one or more additives within ranges not adversely affecting the advantageous effects of the present invention. Exemplary additives include colorants, age inhibitors, antioxidants, ultraviolet absorbers, flame retardants, and stabilizers.

### (Porous Film)

The porous film according to the present invention includes at least the layer A and the layer B. The porous film according to the present invention has a layered structure (multilayer structure) not limited and may for example have a two-layered structure composed of (layer A)/(layer B); and a layered structure including three or more layers including the layer A, the layer B, and one or more other layers. Among them, the porous film is preferably one having a two-layered structure composed of (layer A)/(layer B). The layer A and the layer B are preferably laminated directly on each other without the medium of another layer.

The porous film according to the present invention has a thickness (total thickness) of preferably from 40 to 120 μm, and more preferably from 50 to 100 μm. The porous film, if having a total thickness of less than 40 μm, may suffer from breakage or holes occurring upon production; whereas the porous film, if having a total thickness of more than 120 μm, may invite increased cost and be economically disadvantageous.

The layer A has a thickness of preferably from 5 to 60 μm, and more preferably from 5 to 30 μm. The layer A, if having a thickness of less than 5 μm, may cause the porous film to have insufficient heat sealability; whereas the layer A, if having a thickness of more than 60 μm, may cause the porous film to have insufficient thermal stability and to be less resistant to edge tear. The layer B has a thickness of preferably from 20 to 100 μm, and more preferably from 35 to 95 μm. The layer B, if having a thickness of less than 20 μm, may cause the porous film to have insufficient thermal stability and to be less resistant to edge tear; whereas, the layer B, if having a thickness of more than 100 μm, may invite increased cost and be economically disadvantageous.

The ratio in thickness of the layer A to the layer B [(thickness of layer A):(thickness of layer B)] is preferably from 0.5:9.5 to 5.0:5.0, more preferably from 0.5:9.5 to 3.0:7.0, and furthermore preferably from 0.5:9.5 to 2.0:8.0. The layer A, if having a relative thickness smaller than the above-specified range, may cause the porous film to have insufficient heat sealability. In contrast, the layer B, if having a relative thickness smaller than the above-specified range, may cause the porous film to have insufficient thermal stability and may be susceptible to edge tear upon heat sealing.

The porous film according to the present invention has a heat-seal strength of preferably 10.0 N/25 mm or more (e.g., 10.0 to 30.0 N/25 mm), and more preferably from 10.0 to 25.0 N/25 mm. The heat-seal strength is determined after heat-sealing the layer A side surface of the porous film with a base film surface (surface opposite to pressure-sensitive adhesive layer) of a pressure-sensitive adhesive sheet for body warmers (trade name “Nitotac E12” supplied by Nitta Lifetec Corporation) under conditions of a temperature of 90° C. and a pressure of 4.0 kgf/cm² for a duration of 0.5 second. The porous film, if having a heat-seal strength of less than 10.0 N/25 mm, may cause a bag-constituting member using the porous film to have insufficient heat sealability, and this may cause a bag using the bag-constituting member to be susceptible to breakage. The heat-seal strength is a peel strength measured in a T-peel test under conditions of a tensile speed of 300 mm/min. The heat sealing may be performed typically using a desktop heat seal tester supplied by Tester Sangyo Co., Ltd.

The porous film according to the present invention may be produced by any known or customary method for the production of porous films, which is typified by melting film-formation techniques (e.g., T-die method or tubular film process). Among them, T-die method is preferred. The layer A and the layer B are preferably laminated through coextrusion. More specifically, the porous film may be produced typically according to the following method.

Material pellets for layer A are prepared by mixing with and dispersing in one another the polyethylene (a) and other components according to necessity, such as resinous component(s) (additional resinous component(s)) other than the polyethylene (a), inorganic filler, and various additives, and forming the mixture into pellets using a twin-screw kneader-extruder. Independently, material pellets for layer B are prepared by mixing with and dispersing in one another the polyethylene (b) and other components according to necessity, such as resinous component(s) (additional resinous component(s)) other than the polyethylene (b), inorganic filler, and various additives, and forming the mixture into pellets using a twin-screw kneader-extruder. It is also accepted that melt extrusion is performed by charging materials such as resinous components and inorganic filler directly into a single-screw extruder as mentioned below, without preparing pellets of material mixtures as described above.

Next, while using two single-screw extruders, the material pellets for layer A and the material pellets for layer B are respectively melted in and extruded (coextruded) from the two single-screw extruders, and thereby yield a laminated unstretched film. In addition, the unstretched film is stretched (preferably uniaxially or biaxially stretched) into a porous film and thereby yields a porous film according to the present invention. (The porous film according to the present invention is prepared by stretching the unstretched film to be porous.)

In the production method of the porous film, extrusion is performed at a temperature of preferably from 180° C. to 250° C., and more preferably from 200° C. to 250° C. Haul-off in the preparation of the unstretched film is performed at a speed of preferably from 5 to 25 m/min and at a roll temperature (cooling temperature) of preferably from 5° C. to 30° C., and more preferably from 10° C. to 20° C.

Uniaxial or biaxial (sequential biaxial or simultaneous biaxial) drawing (stretching) of the unstretched film may be performed by known or customary drawing technique such as roll drawing or tenter drawing. The drawing is performed at a temperature of preferably from 50° C. to 100° C., and more preferably from 60° C. to 90° C. The draw ratio (in a uniaxial direction) is preferably from 2 to 5, and more preferably from 3 to 5 from the viewpoints of obtaining a satisfactorily porous film stably. Biaxial drawing, when employed, is performed to an areal draw ratio of preferably from 2 to 10, and more preferably from 3 to 7.

The porous film according to the present invention is used as a constitutive member for a bag-constituting member that is heat-sealed to form a bag. Specifically, the porous film is used for a heat-sealable bag-constituting member. Above all, the porous film is preferably used as a constitutive member of a gas-permeable (air-permeable) bag-constituting member, because the porous film has satisfactory gas permeability and thereby satisfactorily supplies oxygen to the heater. Each of porous films of the present invention may be used alone or in combination with each other to form a bag-constituting member. The porous film according to the present invention, however, is preferably combined with (hybridized with) another gas-permeable material [hereinafter also referred to as “other gas-permeable material”] than the porous film according to the present invention to form a bag-constituting member. Of such other gas-permeable materials, nonwoven fabrics are preferred.

The porous film according to the present invention uses the layer A as a surface layer to be in contact with a counter member (bag-constituting member) upon sealing through heat sealing and uses the layer B as an underlayer (core layer) with respect to the surface layer, in which the layer A contains a polyethylene having a relatively low melting point as a principal resinous component and has satisfactory heat sealability, and the layer B contains a polyethylene having a relatively high melting point as a principal resinous component and has satisfactory thermal stability. A bag-constituting member using the porous film according to the present invention therefore provides satisfactory sealability even upon heat sealing under relatively mild conditions (e.g., low-temperature conditions). Accordingly, the bag-constituting member using the porous film according to the present invention can be sealed under relatively mild heat sealing conditions. In addition, the layer B helps the porous film to have more satisfactory thermal stability to thereby be resistant to edge tear upon heat sealing. Accordingly, the bag-constituting member can be heat-sealed under a relatively wide range of conditions and thereby has better heat sealing workability and better bag productivity. In a preferred embodiment, the resinous components constituting the layer B include a polyethylene having a molecular weight of 30×10⁴ or more (high-molecular-weight component). According to this embodiment, the bag-constituting member has further satisfactory thermal stability and is resistant to edge tear even when heat-sealed under more intense conditions. This enables sealing under more intense heat sealing conditions and enables heat sealing under a wider range of conditions, thus being desirable.

The porous film according to the present invention can be sealed under relatively mild heat sealing conditions, and this enables the use even of nonwoven fabrics made from polymers each having a relatively low melting point, such as polyolefinic polymers (typified by polypropylenes and polyethylenes) as a nonwoven fabric to be laminated (combined) with the porous film. The use of a nonwoven fabric of this kind may enable cost reduction.

The polyolefinic nonwoven fabrics made from polyolefinic polymers are relatively inexpensive and are effective for cost reduction. Among them, polypropylene nonwoven fabrics, polyethylene nonwoven fabrics, and blend nonwoven fabrics of polypropylene fibers and polyethylene fibers are preferred. However, materials constituting the polyolefinic nonwoven fabrics (i.e., materials of fibers constituting the nonwoven fabrics), namely, polyolefins (e.g., polypropylenes and polyethylenes) have relatively low melting points which are relatively near to the melting points of resinous components constituting the porous film. For this reason, when heat-sealed under intense (severe) heat sealing conditions (e.g., at a high heat sealing temperature), a bag-constituting member according to a customary technique may be susceptible to troubles or problems such that the material of the nonwoven fabric melts and adheres to the heat sealing roll; the nonwoven fabric itself, which serves as a reinforcement, melts to cause edge tear; and/or the nonwoven fabric in a heat-sealed portion melts into a film (nonwoven fabric filming) to cause poor appearance.

In contrast, the bag-constituting member using the porous film according to the present invention is sealable under relatively mild heat sealing conditions (e.g., heat sealing at low temperatures) and, even when a nonwoven fabric to be combined with the porous film is a polyolefinic nonwoven fabric, the bag-constituting member can be heat-sealed with little damage on the nonwoven fabric. Accordingly, the porous film according to the present invention can also exhibit advantageous effects particularly when combined with a polyolefinic nonwoven fabric.

### [Bag-Constituting Member]

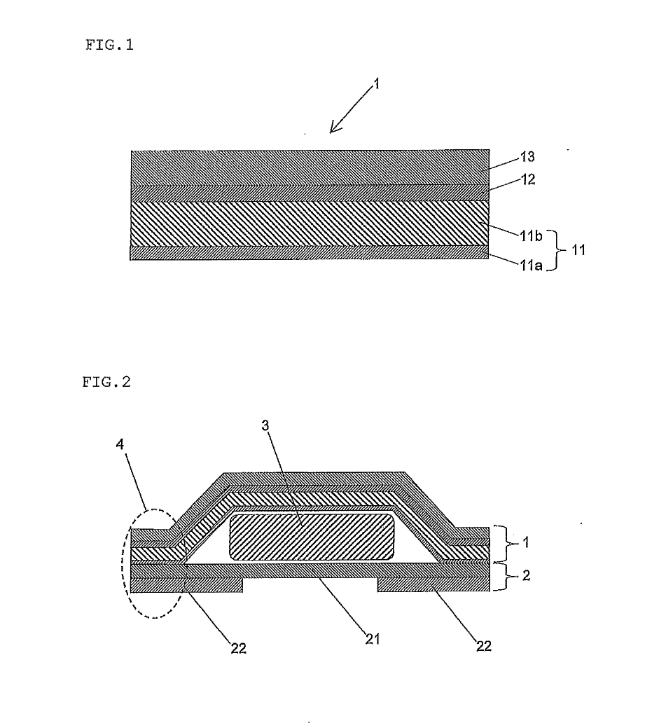

A bag-constituting member (member constituting a bag) may be formed by combining the porous film according to the present invention with another gas-permeable material than the porous film according to the present invention (other gas-permeable material). In this connection, the porous film according to the present invention may be used alone as a bag-constituting member, or two or more porous films according to the present invention may be combined to form a bag-constituting member. Of such bag-constituting members, a bag-constituting member including the porous film according to the present invention; and, arranged on a surface thereof, a nonwoven fabric layer through the medium of an adhesive layer is particularly preferred from the viewpoint of strength. This bag-constituting member is hereinafter also referred to as a “bag-constituting member according to the present invention”. FIG. 1 is a schematic cross-sectional view illustrating an embodiment of a bag-constituting member using the porous film according to the present invention (bag-constituting member including the porous film according to the present invention). The bag-constituting member 1 according to the present invention includes a porous film 11 according to the present invention (including a layer A 11a and a layer B 11b) and a nonwoven fabric layer 13 bonded to each other through the medium of an adhesive layer 12 provided on the layer B 11b.

As the layer A in the porous film according to the present invention is used as a heat-sealable layer of the bag-constituting member, the other gas-permeable material (particularly nonwoven fabric layer) and the adhesive layer are preferably provided on a surface of the porous film according to the present invention opposite to the layer A. Typically, when the porous film according to the present invention has a two-layered structure of (layer A)/(layer B), the nonwoven fabric layer is preferably provided above the layer B side surface of the porous film according to the present invention through the medium of the adhesive layer.

Examples of the other gas-permeable material to be combined with the porous film according to the present invention include fibrous materials such as nonwoven fabrics; and porous films other than the porous film according to the present invention. Among them, nonwoven fabrics are preferred because of having good feel, smooth texture, and a high strength.

The nonwoven fabric (nonwoven fabric layer) for use herein is not limited and can be any of known or customary nonwoven fabrics, such as nonwoven fabrics made from natural fibers and nonwoven fabrics made from synthetic fibers, which are typified by polyamide nonwoven fabrics (e.g., nylon nonwoven fabrics), polyester nonwoven fabrics, polyolefinic nonwoven fabrics (e.g., polypropylene nonwoven fabrics and polyethylene nonwoven fabrics), and rayon nonwoven fabrics. Among them, nylon nonwoven fabrics (also referred to as “nylon-based nonwoven fabrics”, the same is true for other descriptions) are preferred for good feel. Independently, the bag-constituting member using the porous film according to the present invention can undergo heat sealing under relatively mild conditions and thereby also advantageously employs polyolefinic nonwoven fabrics, thus being effective in cost reduction. Of such polyolefinic nonwoven fabrics, preferred are polypropylene nonwoven fabrics (polypropylene-based nonwoven fabrics), polyethylene nonwoven fabrics (polyethylene-based nonwoven fabrics), and nonwoven fabrics of blend of a polypropylene and a polyethylene.

The polyolefinic nonwoven fabrics are not limited but are preferably polypropylene nonwoven fabrics, polyethylene nonwoven fabrics, and nonwoven fabrics of blends of polypropylene fibers and polyethylene fibers (polypropylene/polyethylene-blended nonwoven fabric) from the viewpoint of cost reduction. Specifically, from the viewpoint of cost reduction, the nonwoven fabric layer is preferably a polyolefinic nonwoven fabric layer (layer of a polyolefinic nonwoven fabric), and more preferably a polypropylene nonwoven fabric layer, a polyethylene nonwoven fabric layer, or a nonwoven fabric layer of blend of polypropylene fibers and polyethylene fibers (polypropylene/polyethylene-blended nonwoven fabric layer).

The nonwoven fabric may be prepared according to any process not limited and can be, for example, any of nonwoven fabrics prepared by spunbonding (spunbonded nonwoven fabrics) and nonwoven fabrics prepared by spunlacing (spunlace nonwoven fabrics). Among them, the nonwoven fabric is preferably a spunbonded nonwoven fabric from the viewpoint of strength. The nonwoven fabric may have either a single-layer structure or a multilayer structure. The fiber diameter, fiber length, mass per unit area (METSUKE), and other parameters of the nonwoven fabric are not particularly limited. However, the nonwoven fabric preferably has a mass per unit area of from about 20 to about 100 g/m² and more preferably from about 20 to about 80 g/m², for further satisfactory processability and cost efficiency. The nonwoven fabric may include a fiber of one type or fibers of two or more different types.

In the bag-constituting member, the porous film according to the present invention and the other gas-permeable material (e.g., nonwoven fabric) may be laminated (combined) according to a technique not limited but are preferably affixed to each other with the medium of an adhesive layer, as described above. The “adhesive” for constituting the adhesive layer also includes a “pressure-sensitive adhesive (tacky adhesive)”.

Examples of the adhesive constituting the adhesive layer include, but are not limited to, known adhesives such as rubber adhesives (e.g., natural rubbers and styrenic elastomers), urethane adhesives (acrylic urethane adhesives), polyolefinic adhesives (e.g., ethylene-vinyl acetate copolymers (EVAs) and ethylene-methyl acrylate copolymers (EMAs)), acrylic adhesives, silicone adhesives, polyester adhesives, polyamide adhesives, epoxy adhesives, vinyl alkyl ether adhesives, and fluorine-containing adhesives. Each of such adhesives may be used alone or in combination. Among them, polyolefinic adhesives, polyamide adhesives, and polyester adhesives are typically preferred. Particularly when the porous film and a polyolefinic nonwoven fabric are laminated (combined) with each other, a polyolefinic adhesive is preferably used.

The adhesives for use herein can be adhesives of every form, of which hot-melt (thermofusible) adhesives are preferred, because they can be applied by heating and melting without the use of solvents, can be directly applied even to nonwoven fabrics to form an adhesive layer, and, when the member is heat-sealed, can give a further higher adhesive strength in the heat-sealed portion. Specifically, the adhesives are preferably polyolefinic, polyamide, or polyester hot-melt adhesives, of which polyolefinic, polyamide, or polyester thermoplastic hot-melt adhesives are more preferred.

The specific way to laminate (combine) the porous film according to the present invention and the other gas-permeable material (particularly nonwoven fabric) varies depending typically on the type of the adhesive and is not particularly limited. Typically, when a hot-melt adhesive is used, the lamination is preferably carried out by applying the adhesive to the other gas-permeable material (nonwoven fabric), and bonding the porous film thereonto. The application (coating) can be carried out according to any known or customary procedure used for the application of hot-melt adhesives. The application is preferably carried out by spray coating, stripe coating, or dot coating, typically for maintaining the gas permeability. Though not critical, the mass of coating (in terms of solids content) of the adhesive is preferably from 0.5 to 20 g/m² and more preferably from 1 to 8 g/m², from the viewpoints of adhesion of the heat-sealed portion upon bag formation and economical efficiency.

The bag-constituting member is a heat-sealable bag-constituting member which is heat-sealed to form a bag. The bag-constituting member using the porous film according to the present invention is preferable, because the bag-constituting member is satisfactorily permeable to air, is satisfactorily heat-sealable (is particularly heat-sealable at low temperatures), and is resistant to edge tear after heat sealing. The bag has only to include a bag-constituting member using the porous film according to the present invention (particularly the bag-constituting member according to the present invention) at least as part thereof. Specifically, the bag may be formed by heat sealing two or more plies of the bag-constituting members each using the porous film according to the present invention with each other or may be formed by heat sealing a bag-constituting member using the porous film according to the present invention with a bag-constituting member other than the bag-constituting member using the porous film according to the present invention (hereinafter also referred to as “other bag-constituting member”).

The bag-constituting member is applicable to a variety of uses according to the contents to be enclosed or housed in the bag. For example, the bag-constituting member is preferably used in a disposable body warmer which houses a heater (heating element, exothermic material). In addition, the bag-constituting member is also advantageously used for housing typically of dehumidifiers, deodorants, flavoring agents, and deoxidizers.

### [Disposable Body Warmer]

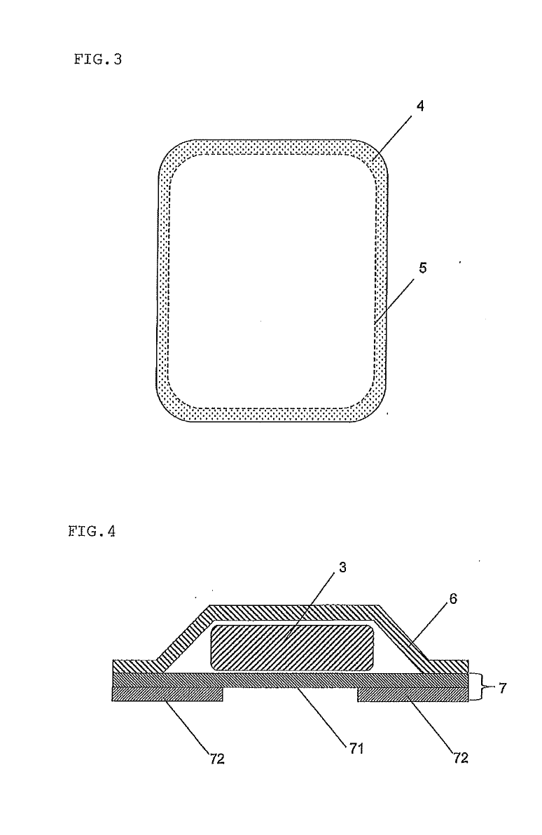

A bag-constituting member using the porous film according to the present invention (particularly the bag-constituting member according to the present invention), when used, can give a disposable body warmer having at least the bag-constituting member. More specifically, such a disposable body warmer can be formed by heat-sealing two plies of a bag-constituting member using the porous film according to the present invention (particularly two plies of the bag-constituting member according to the present invention) with each other, or heat-sealing the bag-constituting member with the other bag-constituting member to form a bag; and enclosing or housing a heater in the bag. FIGS. 2 and 3 are a schematic cross-sectional view and a schematic plan view when viewed from above, respectively, illustrating an exemplary disposable body warmer using the bag-constituting member according to the present invention and another bag-constituting member. The disposable body warmer according to the present invention illustrated in FIGS. 2 and 3 includes a bag and a heater 3 housed in the bag. The bag is formed by heat-sealing the bag-constituting member 1 according to the present invention with another bag-constituting member (other bag-constituting member) 2 at an end portion (heat-sealed portion 4). The other bag-constituting member 2 includes a substrate 21 and a pressure-sensitive adhesive layer 22. In such a disposable body warmer including a pressure-sensitive adhesive layer on one side thereof and intended to be applied to an adherend such as clothing as with one illustrated above, the bag-constituting member using the porous film according to the present invention is preferably used at least as a member (so-called front member) opposite to the side to face the adherend, for supplying oxygen to the heater further sufficiently.

The other bag-constituting member is another bag-constituting member than a bag-constituting member using the porous film according to the present invention and is to be combined with the bag-constituting member using the porous film according to the present invention, as mentioned above. The other bag-constituting member is not particularly limited and can be any of known or customary gas-permeable or non-gas-permeable bag-constituting members. When used in applications where the bag is applied typically to clothing (e.g., as a disposable body warmer to be applied to a body, clothing, or footwear), the other bag-constituting member is preferably a bag-constituting member having a pressure-sensitive adhesive layer, such as a bag-constituting member including a substrate and a pressure-sensitive adhesive layer (bag-constituting member including at least a substrate and a pressure-sensitive adhesive layer). The bag-constituting member of this type is also available as commercial products such as “Nitotac” supplied by Nitto Lifetec Corporation. “Nitotac” is a pressure-sensitive adhesive sheet for body warmers and is a laminate of a heat-sealable polyolefinic substrate and a styrene-isoprene-styrene block copolymer (SIS) pressure-sensitive adhesive layer.

The substrate preferably includes at least one of a heat-sealable layer, a fibrous layer (for example, nonwoven fabric layer), and a film layer. More specific examples of the substrate include a laminate of a heat-sealable layer (inclusive of heat-sealable film layer) and a fibrous layer; a laminate of a heat-sealable layer and a non-heat-sealable film layer; and a substrate having a heat-sealable layer alone.

A nonwoven fabric for use in the nonwoven fabric layer may be any of the nonwoven fabrics mentioned above.

The heat-sealable layer can be formed from a resin having heat sealability (heat-sealable resin) or a heat-sealable resin composition containing one or more heat-sealable resins. Though not limited, the heat-sealable resins are preferably polyolefinic resins (olefinic resins). The polyolefinic resins can be any resins each containing at least an olefinic component as a monomer component. Examples of the olefinic component include α-olefins such as ethylene, propylene, butene-1, pentene-1, hexene-1,4-methyl-pentene-1, heptene-1, and octene-1. Specific examples of the polyolefinic resins include polyethylenes; propylene resins such as polypropylenes and propylene-α-olefin copolymers; polybutene resins such as polybutene-1; and poly-4-methylpentene-1. Exemplary polyolefinic resins usable herein further include copolymers of ethylene and unsaturated carboxylic acids, such as ethylene-acrylic acid copolymers and ethylene-methacrylic acid copolymers; ionomers; copolymers of ethylene and (meth)acrylic esters, such as ethylene-methyl acrylate copolymers, ethylene-ethyl acrylate copolymers, and ethylene-methyl methacrylate copolymers; and ethylene-vinyl alcohol copolymers. Polyethylenes are preferred as the polyolefinic resin for use in the heat-sealable layer, of which low-density polyethylenes, linear low-density polyethylenes, and ethylene-α-olefin copolymers are more preferred. Each of different heat-sealable resins may be used alone or in combination. The heat-sealable layer may have a single-layer structure or a multilayer structure.

Of such heat-sealable resin compositions as mentioned above, preferred are polyolefinic resin compositions each containing at least an ethylene-α-olefin copolymer as a polyolefinic resin, of which polyolefinic resin compositions containing both an ethylene-α-olefin copolymer and at least one of a low-density polyethylene and a linear low-density polyethylene are more preferred. Though not critical, the content of the ethylene-α-olefin copolymer in the polyolefinic resin composition can be chosen within the range of, for example, 5 percent by weight or more, preferably from 10 to 50 percent by weight, and more preferably from 15 to 40 percent by weight, based on the total weight of the polyolefinic resin. For further satisfactory heat sealability at low temperatures, a linear low-density polyethylene prepared by the catalysis of a metallocene catalyst is preferred as the linear low-density polyethylene.

The film layer can be any of customary films. Exemplary material resins for constituting the film layer include polyester resins and polyolefinic resins. Among them, polyolefinic resins are preferred, because they are available inexpensively and have satisfactory flexibility. Resins as with those exemplified in the heat-sealable layer can be used as the polyolefinic resins. The film layer may be either a single-layer film or a multilayer film including two or more layers. Independently, the film layer may be either a non-oriented film, or a uniaxially or biaxially oriented film, but is preferably a non-oriented film.

The thickness of the substrate is not particularly limited and is typically from about 10 to about 500 μm, preferably from about 12 to about 200 μm, and more preferably from about 15 to about 100 μm. The substrate may have undergone one or more treatments, such as backing and antistatic treatments, according to necessity.

The pressure-sensitive adhesive layer provided in the other bag-constituting member plays a role in the affixation of the bag to an adhered upon use. Exemplary pressure-sensitive adhesives for constituting the pressure-sensitive adhesive layer include, but are not limited to, known pressure-sensitive adhesives such as rubber pressure-sensitive adhesives, urethane pressure-sensitive adhesives (acrylic urethane pressure-sensitive adhesives), acrylic pressure-sensitive adhesives, silicone pressure-sensitive adhesives, polyester pressure-sensitive adhesives, polyamide pressure-sensitive adhesives, epoxy pressure-sensitive adhesives, vinyl alkyl ether pressure-sensitive adhesives, and fluorine-containing pressure-sensitive adhesives. Each of different pressure-sensitive adhesives can be used alone or in combination. Among them, rubber and urethane (acrylic urethane) pressure-sensitive adhesives are especialy preferred.

Examples of the rubber pressure-sensitive adhesives include rubber pressure-sensitive adhesives each containing any of natural rubbers and synthetic rubbers as a base polymer. Exemplary rubber pressure-sensitive adhesives each containing a synthetic rubber as a base polymer include styrenic rubbers (also called styrenic elastomers) such as styrene-butadiene (SB) rubbers, styrene-isoprene (SI) rubbers, styrene-isoprene-styrene block copolymer (SIS) rubbers, styrene-butadiene-styrene block copolymer (SBS) rubbers, styrene-ethylene-butylene-styrene block copolymer (SEBS) rubbers, styrene-ethylene-propylene-styrene block copolymer (SEPS) rubbers, styrene-isoprene-propylene-styrene block copolymer (SIPS) rubbers, and styrene-ethylene-propylene block copolymer (SEP) rubbers; polyisoprene rubbers; reclaimed rubbers; butyl rubbers (isobutylene-isoprene rubbers); polyisobutylenes; and modified materials derived from these rubbers. Among them, styrenic elastomer pressure-sensitive adhesives are preferred, of which SIS pressure-sensitive adhesives and SBS pressure-sensitive adhesives are more preferred. Each of these may be used alone or in combination as a mixture.

The urethane pressure-sensitive adhesives can be any of known or customary urethane pressure-sensitive adhesives without limitation, but preferred examples thereof include the urethane pressure-sensitive adhesives illustrated in Japanese Patent No. 3860880 and Japanese Unexamined Patent Application Publication (JP-A) No. 2006-288690. Among them, acrylic urethane pressure-sensitive adhesives including isocyanate/polyester polyols are more preferred. Of the acrylic urethane pressure-sensitive adhesives, preferred are expanded or foamed pressure-sensitive adhesives containing bubbles or foams, from the viewpoint of reducing skin irritation when the bag is applied directly to the skin. Such expanded pressure-sensitive adhesives can be prepared, for example, by a process of compounding a known or customary blowing agent into a pressure-sensitive adhesive.

The pressure-sensitive adhesive may be any of pressure-sensitive adhesives of different forms, such as emulsion pressure-sensitive adhesives, solvent-borne pressure-sensitive adhesives, and thermofusible pressure-sensitive adhesives (hot-melt pressure-sensitive adhesives). Among them, thermofusible pressure-sensitive adhesives (hot-melt pressure-sensitive adhesives) are particularly preferred, because they can be directly applied without using solvents to form pressure-sensitive adhesive layers.

The pressure-sensitive adhesive for use herein can be any of pressure-sensitive adhesives of different types (properties), such as pressure-sensitive adhesives having heat curability (heat-curable pressure-sensitive adhesives), in which crosslinks or other structures are formed upon the application of heat, whereby the adhesives are cured; and pressure-sensitive adhesives having curability by the action of active energy rays (active-energy-ray-curable pressure-sensitive adhesives), in which crosslinks or other structures are formed upon the application of active energy rays, whereby the adhesives are cured. Among them, active-energy-ray-curable pressure-sensitive adhesives are preferred, because they can be free from solvents and are not excessively impregnated into a nonwoven fabric or porous substrate. The heat-curable pressure-sensitive adhesives may further contain one or more of suitable crosslinking agents and polymerization initiators for exhibiting heat curability. The active-energy-ray-curable pressure-sensitive adhesives may further contain one or more of suitable crosslinking agents and photoinitiators for exhibiting curability by the action of active energy rays.

The pressure-sensitive adhesive layer may be protected by a known or customary release film (separator) before use.

A bag-constituting member using the porous film according to the present invention is used to form a bag through heat sealing. The heat sealing may be carried out using any procedure (device), but is preferably carried out through compression bonding with a heat sealer. The heat sealing herein is preferably performed under the following conditions for obtaining both satisfactory sealability and good resistance to edge tear. Specifically, the heat sealing temperature is preferably from 90° C. to 160° C., and more preferably from 90° C. to 130° C. Particularly when the bag-constituting member using the porous film according to the present invention includes a polyolefinic nonwoven fabric, the heat sealing temperature is more preferably from 100° C. to 120° C., and furthermore preferably from 110° C. to 120° C. The heat sealing pressure is preferably from 0.5 to 20 kgf/cm², and more preferably from 2.0 to 20 kgf/cm². The heat sealing time is preferably from 0.001 to 1.0 second, and more preferably from 0.001 to 0.5 second.

A gas-permeable bag-constituting member using a porous film, when subjected to heat sealing under intense or severe conditions (heat sealing temperature: high, heat sealing time: long, heat sealing pressure: high), is susceptible to edge tear, although it has a higher seal strength; whereas the gas-permeable bag-constituting member, when subjected to heat sealing under mild conditions, is susceptible to deterioration in seal strength, thus both being problematic in product quality. For these reasons, when producing bags, such working conditions (workable conditions) should be chosen as to avoid edge tear while maintaining satisfactory seal strength. In an industrial heat sealing process, it generally takes a certain time from the beginning of the working until the working temperature becomes stable. Typically, the heat sealer is deprived of heat by the work during operation, and thereby it takes a certain time until the working temperature reaches an equilibrium. Such a narrow range of the workable conditions causes problems such that it takes a long time from the beginning of the working until the product is obtained, and that nonproduct portions are generated in large amounts. In contrast, the bag-constituting member using the porous film according to the present invention can maintain a satisfactory seal strength even under relatively mild heat sealing conditions, thus enables working under a wide range of working conditions, and is advantageous in productivity and cost. In a preferred embodiment, the bag-constituting member using the porous film according to the present invention employs, as the porous film, a porous film having an underlayer including polyethylenes containing a high-molecular-weight component. The bag-constituting member in this embodiment is resistant to edge tear even when heat-sealed under furthermore intense heat sealing conditions, thus enables working under a further wider range of working conditions, and has furthermore satisfactory properties such as productivity. As used herein the term “edge tear” refers to a phenomenon in which the bag-constituting member tears at a boundary 5 between a heat-sealed portion and a non-heat-sealed portion (see FIG. 3).

In addition, a gas-permeable bag-constituting member including a porous film and a polyolefinic nonwoven fabric combined with each other should be workable particularly under mild heat sealing conditions. Polyolefins (particularly, for example, polyethylenes, polypropylenes, and polypropylene/polyethylene-blended materials) as materials for the polyolefinic nonwoven fabric are inexpensive, but have low melting points which are near to the heat sealing temperature. If working is started while setting the preset temperature of the working machine to be high in consideration that the heat sealer is deprived of heat by the work during heat sealing, the nonwoven fabric melts by the action of heat particularly at the beginning of working (production) and at the time point when the working line is stopped. This often causes problems or troubles such as adhesion of the molten nonwoven fabric to the heat sealing roll and process roll, and occurrence of edge tear. To avoid these, the temperature of the working machine should be set to be a relatively low temperature. In this case, if the bag-constituting member is difficult to be heat-sealed under mild conditions, the range of workable conditions becomes very narrow, and this impairs productivity and is disadvantageous also in cost. The workable conditions are such working conditions that edge tear and problems caused by the nonwoven fabric do not occur while maintaining satisfactory seal strength. In contrast, the bag-constituting member using the porous film according to the present invention, as is described above, can maintain satisfactory seal strength even under relatively mild heat sealing conditions and enables working under a sufficiently wide range of conditions even when the temperature of the working machine is set to a relatively low temperature. For this reason, the bag-constituting member using the porous film according to the present invention provides satisfactory workability and is particularly effective even when employing, as a material to be combined with the porous film according to the present invention, a polyolefinic nonwoven fabric (e.g., a polypropylene nonwoven fabric, a polyethylene nonwoven fabric, or a polypropylene/polyethylene-blended nonwoven fabric).

A disposable body warmer according to the present invention is housed in an outer pouch and is sold as a body warmer product. A base material constituting the outer pouch is not particularly limited and can be any of, for example, plastic base materials; fibrous base materials such as nonwoven fabric base materials and woven fabric base materials made of fibers of various kinds; and metallic base materials such as metal foil base materials made of metallic components of various kinds. Among them, plastic base materials are preferably used as the base material. Examples of the plastic base materials include polyolefinic base materials such as polypropylene base materials and polyethylene base materials; polyester base materials such as poly(ethylene terephthalate) base materials; styrenic base materials including polystyrene base materials, and styrenic copolymer base materials such as acrylonitrile-butadiene-styrene copolymer base materials; amide resin base materials; and acrylic resin base materials. The base material constituting the outer pouch may have a single layer structure or a multilayer structure. Though not critical, the thickness of the outer pouch is preferably from 30 to 300 μm.

In a preferred embodiment, the outer pouch has a layer having gas barrier properties (gas-barrier layer) to inhibit permeation of gaseous components such as oxygen gas and water vapor. The gas-barrier layer is not particularly limited, and examples thereof include oxygen-barrier resin layers such as those made of poly(vinylidene chloride) resins, ethylene-vinyl alcohol copolymers, polyvinyl alcohol)s, and polyamide resins; water-vapor-barrier resin layers such as those made of polyolefins and poly(vinylidene chloride)s; and oxygen-barrier and/or water-vapor-barrier inorganic compound layers, including those made of elementary metals such as aluminum, and those made of metallic compounds including metal oxides such as silicon oxide and aluminum oxide. The gas-barrier layer may be a single layer (e.g., it may be the outer pouch base material itself) or a multilayer laminate.

The outer pouch may be a pouch of any form and structure, such as so-called “four-sided sealed pouch (four side seal pouch),” “three-sided sealed pouch (three side seal pouch),” “pillow style pouch,” “stand-up pouch” (“standing pouch”), or “gusseted pouch.” In a preferred embodiment, the outer pouch is a four-sided sealed pouch. The outer pouch may be prepared using an adhesive, but it is preferably prepared by heat sealing (thermofusing) as typically in a four-sided heat-sealed pouch.

### EXAMPLES

The present invention will be illustrated in further detail with reference to several working examples below. It should be noted, however, that these examples are never construed to limit the scope of the present invention.

### Example 1

### Porous Film

A material mixture (layer A material) for the formation of a surface layer (layer A) was prepared by compounding 100 parts by weight of a metallocene-catalyzed linear low-density polyethylene (metallocene-catalyzed LLDPE) [“Evolue (SP0540)” supplied by Mitsui Chemicals Inc., having a density of 0.903 g/cm³ and a melting point of 98° C.] as a resinous component with 90 parts by weight of a calcium carbonate having an average particle diameter of 3 μm (inorganic microparticles) as an inorganic filler, 1 part by weight of stearic acid as a lubricant, and 1 part by weight of the trade name “Irganox 1010” supplied by Ciba Specialty Chemicals Corporation as an antioxidant, and melting and kneading them at 200° C. in a twin-screw kneader-extruder.

Independently, a material mixture (layer B material) for the formation of an underlayer (layer B) was prepared by compounding 100 parts by weight of a metallocene-catalyzed linear low-density polyethylene (metallocene-catalyzed LLDPE) [“Evolue (SP2320)” supplied by Mitsui Chemicals Inc., having a density of 0.919 g/cm³ and a melting point of 118° C.] as a resinous component, 90 parts by weight of a calcium carbonate having an average particle diameter of 3 μm (inorganic microparticles) as an inorganic filler, 1 part by weight of stearic acid as a lubricant, and 1 part by weight of the trade name “Irganox 1010” supplied by Ciba Specialty Chemicals Corporation as an antioxidant, and melting and kneading them at 200° C. in a twin-screw kneader-extruder.

Next, melt extrusion was performed using two single-screw extruders. Specifically, the layer A material and the layer B material were subjected to melt extrusion respectively in the two single-screw extruders at 220° C., were coextruded through a two-layer-forming T-die, and thereby yielded an unstretched film having a two-layered structure of (layer A)/(layer B).

In addition, the unstretched film was drawn (stretched) through uniaxial roll drawing at a drawing temperature of 80° C. in a longitudinal direction (machine direction, MD) to a draw ratio of 4.0, thereby allowed to be porous, and yielded a porous film having a thickness of 70 μm and having a two-layered structure.

The porous film had a thickness of the surface layer (layer A) of 10 μm and a thickness of the underlayer (layer B) of 60 μm.

### (Bag-Constituting Member)

Next, a polyamide hot-melt adhesive was applied in a mass of coating of 5 g/m² to a nylon spunbonded nonwoven fabric having a mass per unit area of 40 g/m² through spray coating, and the nonwoven fabric was affixed to the underlayer (layer B)-side surface of the above-obtained porous film and thereby yielded a bag-constituting member (gas-permeable bag-constituting member; bag-constituting member according to the present invention).

The nonwoven fabric used herein was a nylon spunbonded nonwoven fabric (trade name “ELTAS N03040”) supplied by Asahi Kasei Fibers Corporation. The adhesive used herein was the trade name “VESTAMELT” supplied by Daicel-Evonik Ltd. (former Daicel-Huels Ltd.).

### (Disposable Body Warmer)

Next, a disposable body warmer was prepared.

Specifically, the above-prepared bag-constituting member and a pressure-sensitive adhesive sheet for body warmers (trade name “Nitotac E12” supplied by Nitto Lifetec Corporation) (non-gas-permeable bag-constituting member; other bag-constituting member) were each cut to 130 mm long (MD: machine direction) and 95 mm wide (CD: cross direction) and cut members were laid on each other so that the porous film surface (surface of the surface layer (layer A)) of the above-prepared bag-constituting member faced the surface of the base film (surface opposite to the pressure-sensitive adhesive layer) of the pressure-sensitive adhesive sheet for body warmers, were heat-sealed while housing and enclosing a heater therebetween, and thereby yielded a disposable body warmer.

The heat sealing was performed using a desktop heat seal tester supplied by Tester Sangyo Co., Ltd. at a pressure of 4.0 kgf/cm² for a sealing time of 0.5 second. The above procedure was repeated, except for changing the heat sealing temperature to 70° C., 80° C., 90° C., 100° C., 110° C., 120° C., 130° C., 140° C., 150° C., and 160° C. as described later to give a series of disposable body warmers prepared at the respective heat sealing temperatures.

In the above process, four sides of the work were heat-sealed in a width of 5 mm. The heater used herein is contents of a commercially available body warmer and is a mixture mainly containing an iron powder.

### Example 2

A porous film having a thickness of 70 μm and having a two-layered structure was prepared by the procedure of Example 1, except that the porous film has a thickness of the surface layer (layer A) of 30 μm and a thickness of the underlayer (layer B) of 40 μm.

Except for using the above-prepared porous film, a bag-constituting member and a disposable body warmer were prepared by the procedure of Example 1.

### Example 3

A bag-constituting member and a disposable body warmer were prepared by the procedure of Example 1 using the same porous film as with Example 1, except for changing the nonwoven fabric to a polypropylene spunbonded nonwoven fabric (trade name “ELTAS P03040” supplied by Asahi Kasei Fibers Corporation, having a mass per unit area of 40 g/m²).

### Example 4

A porous film, a bag-constituting member, and a disposable body warmer were prepared by the procedure of Example 1, except for using 85.7 parts by weight of a metallocene-catalyzed LLDPE [“Evolue (SP2320)” supplied by Mitsui Chemicals Inc.] and 14.3 parts by weight of a polyethylene having a molecular weight of from 30×10⁴ to 250×10⁴ (having a weight-average molecular weight of 79×10⁴) as the resinous components for use in the material mixture (layer B material) for the formation of the underlayer (layer B), instead of 100 parts by weight of the metallocene-catalyzed LLDPE [“Evolue (SP2320)” supplied by Mitsui Chemicals Inc.].

### Example 5

A bag-constituting member and a disposable body warmer were prepared by the procedure of Example 1 using the same porous film as with Example 1, except for changing the nonwoven fabric to a polypropylene/polyethylene-blended nonwoven fabric (trade name “Haibon 9540F” supplied by SHINWA Corp., having a mass per unit area of 40 g/m²).

### Example 6

A bag-constituting member and a disposable body warmer were prepared by the procedure of Example 1 using the same porous film as with Example 1, except for changing the nonwoven fabric to a polyethylene nonwoven fabric (trade name “Tyvek 1056B” supplied by E.I. du Pont de Nemours and Company, having a mass per unit area of 56 g/m²).

### Example 7

A porous film, a bag-constituting member, and a disposable body warmer were prepared by the procedure of Example 1, except for using 100 parts by weight of a metallocene-catalyzed LLDPE [“Evolue (SP3010)” supplied by Mitsui Chemicals Inc., having a density of 0.925 g/cm³ and a melting point of 124° C.] as the resinous component for use in the material mixture (layer B material) for the formation of the underlayer (layer B), instead of 100 parts by weight of the metallocene-catalyzed LLDPE [“Evolue (SP2320)” supplied by Mitsui Chemicals Inc.].

### Comparative Example 1

### Porous Film

A material mixture was prepared by compounding 100 parts by weight of a metallocene-catalyzed linear low-density polyethylene (metallocene-catalyzed LLDPE) [“Evolue (SP2320)” supplied by Mitsui Chemicals Inc., having a density of 0.919 g/cm³ and a melting point of 118° C.] as a resinous component, 90 parts by weight of a calcium carbonate having an average particle diameter of 3 μm (inorganic microparticles) as an inorganic filler, 1 part by weight of stearic acid as a lubricant, and 1 part by weight of the trade name “Irganox 1010” supplied by Ciba Specialty Chemicals Corporation as an antioxidant, and melting and kneading them at 200° C. in a twin-screw kneader-extruder.

Using one single-screw extruder alone, melting and extrusion was performed. Specifically, the material mixture was melted in and extruded from the single-screw extruder at 210° C. and thereby yielded a single-layer unstretched film.

Next, the unstretched film was drawn through uniaxial roll drawing in a longitudinal direction (MD) at a drawing temperature of 80° C. to a draw ratio of 4.0 to be porous, and thereby yielded a single-layer porous film having a thickness of 70 μm.

A bag-constituting member and a disposable body warmer were prepared by the procedure of Example 1, except for using the above-prepared single-layer porous film.

### Comparative Example 2

A bag-constituting member and a disposable body warmer were prepared by the procedure of Comparative Example 1 using the same porous film as with Comparative Example 1, except for changing the nonwoven fabric to a polypropylene spunbonded nonwoven fabric (trade name “ELTAS P03040” supplied by Asahi Kasei Fibers Corporation, having a mass per unit area of 40 g/m²).

### Comparative Example 3

A material mixture was prepared by compounding 100 parts by weight of a metallocene-catalyzed linear low-density polyethylene (metallocene-catalyzed LLDPE) [“Evolue (SP0540)” supplied by Mitsui Chemicals Inc., having a density of 0.903 g/cm³ and a melting point of 98° C.] as a resinous component, 90 parts by weight of a calcium carbonate having an average particle diameter of 3 μm (inorganic microparticles) as an inorganic filler, 1 part by weight of stearic acid as a lubricant, and 1 part by weight of the trade name “Irganox 1010” supplied by Ciba Specialty Chemicals Corporation as an antioxidant, and melting and kneading them at 200° C. in a twin-screw kneader-extruder.

Using one single-screw extruder alone, melting and extrusion was performed. Specifically, the material mixture was melted in and extruded from the single-screw extruder at 210° C. and thereby yielded a single-layer unstretched film.

Next, the unstretched film was drawn through uniaxial roll drawing at a drawing temperature of 80° C. in a longitudinal direction (MD) to a draw ratio of 4.0 to be porous, and thereby yielded a single-layer porous film having a thickness of 70 μm.

A bag-constituting member and a disposable body warmer were prepared by the procedure of Comparative Example 2, except for using the above-prepared single-layer porous film.

### Comparative Example 4

A bag-constituting member and a disposable body warmer were prepared by the procedure of Comparative Example 1 using the same porous film as with Comparative Example 1, except for changing the nonwoven fabric to a polypropylene/polyethylene-blended nonwoven fabric (trade name “Haibon 9540F” supplied by SHINWA Corp., having a mass per unit area of 40 g/m²).

### Comparative Example 5

A bag-constituting member and a disposable body warmer were prepared by the procedure of Comparative Example 3 using the same porous film as with the Comparative Example 3, except for changing the nonwoven fabric to a polypropylene/polyethylene-blended nonwoven fabric (trade name “Haibon 9540F” supplied by SHINWA Corp., having a mass per unit area of 40 g/m²).

### (Evaluations)

### (1) Measurement of Melting Point (Differential Scanning Calorimetry: DSC)

Measurement samples were prepared by shaving off the layer A from the layer A surface (layer A-side surface) of the porous films (two-layered porous films) prepared (or used) in Examples 1 to 7. The layer A was shaved off in a range down to about 5 μm deep from the surface, using a microtome. The measurement samples were subjected to thermal analyses through DSC to determine endothermic peaks, from which the melting point(s) of resin(s) constituting the layer A were determined.

Likewise, measurement samples were prepared by shaving off the layer B from the layer B surface (layer B-side surface) of the porous films prepared (or used) in Examples 1 to 7. The layer B was shaved off in a range down to about 10 μm deep from the surface using a microtome. The measurement samples were subjected to thermal analyses through DSC to determine endothermic peaks, from which the melting point(s) of resin(s) constituting the layer B were determined.

Independently, measurement samples were prepared in the same manner as above by shaving off the porous films prepared (or used) in Comparative Examples 1 to 5. Each of the films was shaved off from one side of the porous film in a range down to about 10 μm deep from the surface using a microtome. The measurement samples were subjected to thermal analyses through DSC to determine endothermic peaks, from which the melting point(s) of resin(s) constituting the films were determined.

The thermal analyses for melting point measurement were performed by using, a measurement instrument, the device name “DSC 200” supplied by Seiko Instruments Inc. under such conditions that the temperature was raised from room temperature to 200° C. at a rate of temperature rise of 10° C./min.

The melting point measurements revealed that, in the porous film prepared (or used) in Examples 1 to 3 and Examples 5 and 6, the resin constituting the surface layer (layer A) has a melting point of 98° C., and the resin constituting the underlayer (layer B) has a melting point of 118° C. In the porous film prepared in Example 4, the resin constituting the surface layer (layer A) has a melting point of 98° C., and the resins constituting the underlayer (layer B) have melting points of 118° C. and 130° C. In the porous film prepared in Example 7, the resin constituting the surface layer (layer A) has a melting point of 98° C., and the resin constituting the underlayer (layer B) has a melting point of 124° C.

In the porous film prepared (or used) in Comparative Examples 1, 2, and 4, the resin constituting the film has a melting point of 118° C. In the porous film prepared (or used) in Comparative Examples 3 and 5, the resin constituting the film has a melting point of 98° C.

### (2) Heat Sealing Workability [Heat-Seal Strength and State of Porous Film and Nonwoven Fabric in Heat-Sealed Portion Under Different Heat Sealing Conditions]

Disposable body warmers were prepared using bag-constituting members, as described in the examples and comparative examples. In this procedure, the heat sealing working temperature (heat sealing temperature) was changed to 70° C., 80° C., 90° C., 100° C., 110° C., 120° C., 130° C., 140° C., 150° C., and 160° C., and the resulting disposable body warmers prepared at respective working temperatures were examined on heat-seal strength (seal strength) and on state of the porous film and the nonwoven fabric in a heat-sealed portion. The disposable body warmers were examined according to the following methods.

The “heat sealing temperature” herein is the temperature of a seal bar of the heat seal tester.

### (2-1) Heat-Seal Strength (Seal Strength)

The disposable body warmers prepared under different working conditions (at different heat sealing temperatures) were subjected to T-peel tests under conditions mentioned below to measure peel strength. Specifically, T-peel was performed between the bag-constituting member (composite member of a porous film and a nonwoven fabric) and the pressure-sensitive adhesive sheet for body warmers (Nitotac) as both ends. The peel strength is a peel strength between the bag-constituting member and the pressure-sensitive adhesive sheet for body warmers in a heat-sealed portion. The measured peel strength of a sample was defined as the heat-seal strength (N/25 mm).

Instrument: “Shimadzu Autograph” supplied by Shimadzu Corporation

Sample width: 25 mm

Tensile speed: 300 mm/min.

Tensile direction: Cross direction (CD; direction perpendicular to the machine direction (MD))

Ambient temperature and humidity: 23° C., relative humidity of 50%

Number of repeated tests: n=3

The heat-seal strength was evaluated according to the following criteria:

N/25 mm or more: Good sealability (A)

5 N/25 mm or more and less than 10 N/25 mm: Rather insufficient sealing (unusable) (B)

Less than 5 N/25 mm: Insufficient sealing (C)

### (2-2) State of Porous Film and Nonwoven Fabric in Heat-Sealed Portion

Each five specimens of disposable body warmers were prepared under the respective working conditions (at respective heat sealing temperatures), and all the prepared disposable body warmers were visually observed and examined on state of the porous film and nonwoven fabric in the heat-sealed portion.

The state of the porous film and nonwoven fabric was determined according to the following criteria by observing whether or not an edge tear having a length of 1 mm or more occurs in the porous film, and observing whether or not a filming of the nonwoven fabric having a size (length of the longest portion) of 3 mm or more occurs.

None of five disposable body warmers suffers from edge tear and filming of nonwoven fabric: Porous film and nonwoven fabric are in good state (A)

None of disposable body warmers suffers from edge tear but one or more of them suffer from filming of nonwoven fabric: Porous film and nonwoven fabric are in not so good state (B)

One or more of five disposable body warmers suffer from edge tear: Porous film and nonwoven fabric are in poor state (C)

As used herein the term “filming of nonwoven fabric” refers to such a state that the nonwoven fabric melts to form a film in the sealed portion and thereby suffers from deterioration in properties such as feel. Further, as the nonwoven fabric melts into a film, the edge thereof may be ruptured.

### (2-3) Range of Heat-Sealable Temperatures

The range of temperatures at which the seal strength and the state of the porous film and nonwoven fabric in a heat-sealed portion are both good (A) in the above evaluations (2-1) and (2-2) was defined as the range of heat-sealable temperatures.

The evaluation results on heat sealing workability are shown in Table 1.

TABLE 1

| Heat sealing | | | | | | | |
|---|---|---|---|---|---|---|---|
| temperature | | Example 1 | Example 2 | Example 3 | Example 4 | Example 5 | Example 6 |
| 70° C. | Heat-seal strength | 6.5 | 5.5 | 6.0 | 6.2 | 6.5 | 6.0 |
| | (N/25 mm) | B | B | B | B | B | B |
| | State of porous film and | A | A | A | A | A | A |
| | nonwoven fabric | | | | | | |
| | Sealing state | Rather | Rather | Rather | Rather | Rather | Rather |
| | | insufficient | insufficient | insufficient | insufficient | insufficient | insufficient |
| | | sealing | sealing | sealing | sealing | sealing | sealing |
| 80° C. | Heat-seal strength | 14.0 | 14.0 | 14.0 | 13.6 | 14.5 | 14.0 |
| | (N/25 mm) | A | A | A | A | A | A |
| | State of porous film and | A | A | A | A | A | A |
| | nonwoven fabric | | | | | | |
| | Sealing state | Good | Good | Good | Good | Good | Good |
| 90° C. | Heat-seal strength | 16.0 | 16.5 | 16.0 | 17.5 | 16.0 | 16.5 |
| | (N/25 mm) | A | A | A | A | A | A |
| | State of porous film and | A | A | A | A | A | A |
| | nonwoven fabric | | | | | | |
| | Sealing state | Good | Good | Good | Good | Good | Good |
| 100° C. | Heat-seal strength | 20.0 | 19.5 | 19.5 | 20.5 | 19.0 | 19.5 |
| | (N/25 mm) | A | A | A | A | A | A |
| | State of porous film and | A | A | A | A | A | A |
| | nonwoven fabric | | | | | | |
| | Sealing state | Good | Good | Good | Good | Good | Good |
| 110° C. | Heat-seal strength | 18.5 | 19.5 | 19.5 | 20.0 | 19.5 | 20.0 |
| | (N/25 mm) | A | A | A | A | A | A |
| | State of porous film and | A | A | A | A | A | A |
| | nonwoven fabric | | | | | | |
| | Sealing state | Good | Good | Good | Good | Good | Good |
| 120° C. | Heat-seal strength | 19.5 | 20.0 | 20.5 | 21.0 | 20.0 | 20.0 |
| | (N/25 mm) | A | A | A | A | A | A |
| | State of porous film and | A | A | A | A | A | A |
| | nonwoven fabric | | | | | | |
| | Sealing state | Good | Good | Good | Good | Good | Good |
| 130° C. | Heat-seal strength | 20.0 | 19.5 | 19.5 | 21.5 | 19.5 | 19.0 |
| | (N/25 mm) | A | A | A | A | A | A |
| | State of porous film and | A | A | A | A | A | A |
| | nonwoven fabric | | | | | | |
| | Sealing state | Good | Good | Good | Good | Good | Good |
| 140° C. | Heat-seal strength | 19.0 | 19.5 | 18.5 | 19.8 | 18.0 | 18.0 |
| | (N/25 mm) | A | A | A | A | A | A |
| | State of porous film and | A | A | A | A | B | B |
| | nonwoven fabric | | | | | | |
| | Sealing state | Good | Good | Good | Good | Filming of | Filming of |
| | | | | | | nonwoven | nonwoven |
| | | | | | | fabric | fabric |
| 150° C. | Heat-seal strength | 17.5 | 16.0 | 17.0 | 17.5 | 16.5 | 16.0 |
| | (N/25 mm) | A | A | A | A | A | A |
| | State of porous film and | C | C | C | A | C | C |
| | nonwoven fabric | | | | | | |
| | Sealing state | Edge tear | Edge tear | Edge tear | Good | Edge tear | Edge tear |
| | | of porous | of porous | of porous | | of porous | of porous |
| | | film | film | film and | | film and | film and |
| | | | | filming of | | filming of | filming of |
| | | | | nonwoven | | nonwoven | nonwoven |
| | | | | fabric | | fabric | fabric |
| 160° C. | Heat-seal strength | 16.0 | 15.0 | 15.5 | 17.0 | — | — |
| | (N/25 mm) | A | A | A | A | — | — |
| | State of porous film and | C | C | C | C | — | — |
| | nonwoven fabric | | | | | | |
| | Sealing state | Edge tear | Edge tear | Edge tear | Edge tear | — | — |
| | | of porous | of porous | of porous | of porous | | |
| | | film | film | film and | film | | |
| | | | | filming of | | | |
| | | | | nonwoven | | | |
| | | | | fabric | | | |
| Range of heat-sealable | | about | about | about | about | about | about |
| temperatures | | 60° C. | 60° C. | 60° C. | 70° C. | 50° C. | 50° C. |
| Heat sealing | | | | | | | |
| temperature | | Example 7 | Com. Ex. 1 | Com. Ex. 2 | Com. Ex. 3 | Com. Ex. 4 | Com. Ex. 5 |
| 70° C. | Heat-seal strength | 6.5 | 1.3 | 1.5 | 6.0 | 1.5 | 6.5 |
| | (N/25 mm) | B | C | C | B | C | B |
| | State of porous film and | A | A | A | A | A | A |
| | nonwoven fabric | | | | | | |
| | Sealing state | Rather | Insufficient | Insufficient | Rather | Insufficient | Rather |
| | | insufficient | sealing | sealing | insufficient | sealing | insufficient |
| | | sealing | | | sealing | | sealing |
| 80° C. | Heat-seal strength | 13.5 | 3.5 | 3.5 | 13.5 | 3.5 | 14.0 |
| | (N/25 mm) | A | C | C | A | C | A |
| | State of porous film and | A | A | A | A | A | A |
| | nonwoven fabric | | | | | | |
| | Sealing state | Good | Insufficient | Insufficient | Good | Insufficient | Good |
| | | | sealing | sealing | | sealing | |
| 90° C. | Heat-seal strength | 17.5 | 9.5 | 9.3 | 17.0 | 9.0 | 16.5 |
| | (N/25 mm) | A | B | B | A | B | A |
| | State of porous film and | A | A | A | A | A | A |
| | nonwoven fabric | | | | | | |
| | Sealing state | Good | Rather | Rather | Good | Rather | Good |
| | | | insufficient | insufficient | | insufficient | |
| | | | sealing | sealing | | sealing | |
| 100° C. | Heat-seal strength | 20.0 | 15.0 | 14.5 | 20.5 | 15.0 | 20.0 |
| | (N/25 mm) | A | A | A | A | A | A |
| | State of porous film and | A | A | A | A | A | A |
| | nonwoven fabric | | | | | | |
| | Sealing state | Good | Good | Good | Good | Good | Good |
| 110° C. | Heat-seal strength | 20.0 | 18.5 | 18.5 | 21.5 | 18.5 | 21.0 |
| | (N/25 mm) | A | A | A | A | A | A |
| | State of porous film and | A | A | A | A | A | A |
| | nonwoven fabric | | | | | | |
| | Sealing state | Good | Good | Good | Good | Good | Good |
| 120° C. | Heat-seal strength | 21.0 | 20.0 | 19.0 | 9.5 | 20.0 | 9.0 |
| | (N/25 mm) | A | A | A | B | A | B |
| | State of porous film and | A | A | A | C | A | C |
| | nonwoven fabric | | | | | | |
| | Sealing state | Good | Good | Good | Edge tear | Good | Edge tear |
| | | | | | of porous | | of porous |
| | | | | | film | | film |
| 130° C. | Heat-seal strength | 21.0 | 20.0 | 20.5 | — | 19.0 | — |
| | (N/25 mm) | A | A | A | — | A | — |
| | State of porous film and | A | A | A | — | A | — |
| | nonwoven fabric | | | | | | |
| | Sealing state | Good | Good | Good | — | Good | — |
| 140° C. | Heat-seal strength | 19.0 | 18.5 | 19.0 | — | 18.5 | — |
| | (N/25 mm) | A | A | A | — | A | — |
| | State of porous film and | A | A | A | — | B | — |
| | nonwoven fabric | | | | | | |
| | Sealing state | Good | Good | Good | — | Filming of | — |
| | | | | | | nonwoven | |
| | | | | | | fabric | |
| 150° C. | Heat-seal strength | 17.5 | 18.5 | 17.0 | — | 17.0 | — |
| | (N/25 mm) | A | A | A | — | A | — |
| | State of porous film and | A | C | C | — | C | — |
| | nonwoven fabric | | | | | | |
| | Sealing state | Good | Edge tear | Edge tear | — | Edge tear | — |
| | | | of porous | of porous | | of porous | |
| | | | film | film and | | film and | |
| | | | | filming of | | filming of | |
| | | | | nonwoven | | nonwoven | |
| | | | | fabric | | fabric | |
| 160° C. | Heat-seal strength | 17.0 | 16.5 | 15.0 | — | — | — |
| | (N/25 mm) | A | A | A | — | — | — |
| | State of porous film and | C | C | C | — | — | — |
| | nonwoven fabric | | | | | | |
| | Sealing state | Edge tear | Edge tear | Edge tear | — | — | — |
| | | of porous | of porous | of porous | | | |
| | | film | film | film and | | | |
| | | | | filming of | | | |
| | | | | nonwoven | | | |
| | | | | fabric | | | |

| | | | | | | |
|---|---|---|---|---|---|---|
| Range of heat-sealable | about | about | about | about | about | about |
| temperatures | 70° C. | 40° C. | 40° C. | 30° C. | 30° C. | 30° C. |

As is demonstrated by Table 1, bag-constituting members using the porous films according to the present invention (Examples) each have a wide range of heat-sealable temperatures upon production of disposable body warmers, namely, they are heat-sealable under a wide range of conditions and excel in workability (productivity of disposable body warmers). The range of heat-sealable temperatures is the range of working temperatures at which neither insufficient sealing nor inferior sealing state occurs. In addition, even the samples using a polyolefinic nonwoven fabric (Examples 3, 5, and 6) can undergo heat sealing under a wide range of conditions. Among them, the sample employing a polyethylene having a molecular weight of 30×10⁴ or more in the underlayer of the porous film (Example 4) can give a bag-constituting member which is more resistant to edge tear at high temperatures, has a wider range of heat-sealable temperatures, and has furthermore satisfactory workability.

In contrast, the bag-constituting members each using a single-layer porous film (comparative examples) each have a narrow range of heat-sealable temperatures and are inferior in workability, as compared to the bag-constituting members using the porous film according to the present invention. The single-layer porous film is a porous film composed of the underlayer alone of the porous film prepared (or used) in Examples 1 to 3 and Example 5 and 6, or a porous film composed of the surface layer alone of the porous film prepared (or used) in the examples.

### INDUSTRIAL APPLICABILITY

The porous film for a heat-sealable bag-constituting member according to the present invention has two porous film layers, in which one porous film includes a polyethylene having a relatively low melting point as a principal resinous component and excels in heat sealability, and the other includes a polyethylene having a higher melting point as a principal resinous component and excels in thermal stability. Owing to this configuration, the porous film is heat-sealable under a wide range of sealing conditions from relatively mild conditions to relatively intense conditions. The porous film according to the present invention is therefore useful as a constitutive member of a bag-constituting member for the formation of a bag through heat sealing (e.g., a bag-constituting member for disposable body warmers).

### REFERENCE SIGNS LIST

1 bag-constituting member according to the present invention (gas-permeable bag-constituting member)
11 porous film according to the present invention
11a porous film layer (layer A; surface layer)
11b porous film layer (layer B; underlayer)
12 adhesive layer
13 nonwoven fabric layer
2 other bag-constituting member (non-gas-permeable bag-constituting member)
21 substrate
22 pressure-sensitive adhesive layer
3 heater
4 heat-sealed portion
5 boundary between heat-sealed portion and non-heat-sealed portion
6 bag-constituting member (front member)
7 bag-constituting member (back member)
71 substrate
72 pressure-sensitive adhesive layer

1. A porous film for a heat-sealable bag-constituting member, the porous film comprising: a porous film layer (layer A); and another porous film layer (layer B), wherein resinous component(s) constituting the layer A contains 50 percent by weight or more of at least one polyethylene (a) having a melting point of 90° C. or higher and lower than 110° C., and wherein resinous component(s) constituting the layer B contains 50 percent by weight or more of at least one polyethylene (b) having a melting point of 110° C. or higher and 140° C. or lower.

2. The porous film for a heat-sealable bag-constituting member according to claim 1, wherein the porous film has a ratio in thickness of the layer A to the layer B [(layer A):(layer B)] of from 0.5:9.5 to 5.0:5.0 and has a total thickness of from 40 to 120 μm.

3. A heat-sealable bag-constituting member comprising: the porous film for a heat-sealable bag-constituting member of claim 1; and a nonwoven fabric layer provided above a surface of the layer B side of the porous film through the medium of an adhesive layer.

4. The heat-sealable bag-constituting member according to claim 3, wherein the nonwoven fabric layer is a polyolefinic nonwoven fabric layer.

5. A disposable body warmer comprising the heat-sealable bag-constituting member of claim 3.

6. A heat-sealable bag-constituting member comprising: the porous film for a heat-sealable bag-constituting member of claim 2; and a nonwoven fabric layer provided above a surface of the layer B side of the porous film through the medium of an adhesive layer.

7. The heat-sealable bag-constituting member according to claim 6, wherein the nonwoven fabric layer is a polyolefinic nonwoven fabric layer.

8. A disposable body warmer comprising the heat-sealable bag-constituting member of claim 4.

9. A disposable body warmer comprising the heat-sealable bag-constituting member of claim 6.

10. A disposable body warmer comprising the heat-sealable bag-constituting member of claim 7.
